(19) United States
(12) Patent Application Publication
(10) Pub. No.: US 2021/0135243 A1
(43) Pub. Date: May 6, 2021

(54) ANODE CATALYST COATING FOR USE IN AN ELECTROCHEMICAL DEVICE

(71) Applicant: BAR ILAN UNIVERSITY, Ramat Gan (IL)

(72) Inventors: David Zitoun, Raanana (IL); Gregory Gershinsky, Ramat Gan (IL)

(21) Appl. No.: 16/491,786

(22) PCT Filed: Mar. 6, 2018
(86) PCT No.: PCT/IL2018/050254

§ 371 Date: Sep. 6, 2019

Related U.S. Application Data
(60) Provisional application No. 62/467,260, filed on Mar. 6, 2017.

(51) Int. Cl. H01M 4/86; H01M 4/92; H01M 8/18; H01M 8/1004; C25B 11/051; C25B 11/095; C25B 11/093

(52) U.S. Cl. CPC H01M 4/8663; H01M 4/92; H01M 8/188; H01M 2004/8684; C25B 11/051; C25B 11/095; C25B 11/093; H01M 8/1004

(57) ABSTRACT

The present invention provides a durable catalyst for use in redox flow batteries, fuel cells and electrolyzers. More specifically, the invention provides an anode catalyst endowed with superior stability for use in highly poisonous environments.

### TECHNOLOGICAL FIELD

The present invention generally relates to coating of catalysts with improved durability for use in a redox flow battery, fuel cells and electrolyzers and methods of use.

### BACKGROUND

Electrochemical reactions, energy storage and conversion are based on electrodes usually acting as electro-catalysts for the redox reaction. In most of the cases, the catalyst needs to be highly electro-active towards the reagents species and sustain unwanted reactions with the electrolyte and contaminants. For instance, the chlorine industry uses electrolysis for the production of chlorine from salt, where the redox reaction of Cl⁻ to C12 on the catalysts can be impeded by the reaction of Cl⁻ and C12 with the electrode.

As a relevant example, redox-flow batteries (RFBs) are considered one of the most promising energy storage systems for stationary substation applications to meet the cost target, for which many chemistries are explored and developed, including, for example, all-vanadium, zinc-bromide and the more exploratory hydrogen-bromine. Stationary RFBs are electrochemical energy storage devices, namely, devices wherein a reversible chemical change occurs within a liquid electrolyte that enables rapid storage and release of energy. They have numerous advantages as compared to solid state electrolyte batteries such as Li-ion, the advantage being, for example, a high scalability and short response time. One of the most attractive feature of the RFB is the decoupled functionality of power and energy and this inherent feature makes them most suited for any medium to large-scale application. It is a type of electrochemical storage technology and has the advantages of modularity and fast response times (in the order of milliseconds), thereby making them highly suitable for power quality and energy management applications. Taking into account existing chemistries and their advantages and challenges, the stationary energy storage market needs new alternatives for the RFB system's setup to obtain improved results with novel materials with lower power and energy costs.

Potential hydrogen bromine (HBr) RFB technology offers fundamentally the most economic storage solution and is considered most promising for a sustainable electricity storage solution due to fast kinetics, highly reversible reactions and low chemical costs. HBr has numerous advantages compared to solid-state electrolyte batteries, including the possibility to scale the power input/output independently of the capacity of the system. HBr also has competitive advantages in comparison with other RFB systems of which the predominant one is the large-scale availability of both hydrogen and bromine.

The main bottleneck of conventional electrodes is the rapid fading of the catalyst performance in the highly corrosive environment [1].

KR101641145 [2] describes a method of producing a metal or metal oxide catalyst complex on a support body for a fuel cell using polydopamine, and US2015/0255802 [3] describes a method for preparing an alloy catalyst for fuel cells, by coating a platinum or platinum-transition metal catalyst supported on carbon with polydopamine as a capping agent.

### REFERENCES

### [1] WO2016/183356

### [2] KR101641145

### [3] US2015/0255802

### SUMMARY OF THE INVENTION

Thus, it is the purpose of the present invention to provide a durable catalyst that may be efficiently used in redox flow batteries, fuel cells and electrolyzers.

More specifically, one objective of the present invention is to provide an anode catalyst that is endowed with superior stability in a highly poisonous environment, when operated in such redox flow battery systems, while exhibiting an improved performance. The stability is related to the fact that an anode catalyst is required to effectively electro-oxidize hydrogen (e.g., H₂/Br₂ redox flow battery), while maintaining stable and continuous functioning and durability in a highly corrosive environment that is formed during prolonged operation of the cell. In addition, the catalyst electro-reduces protons of hydronium when the cell charges, such that functionality of the catalyst must be maintained in both the electro-oxidation stage and the electro-reduction stage.

In accordance with the invention, stability and functionality are achieved by encapsulating or engulfing or by forming a coating or a protective film of a material (a capping material) on any exposed surface of a transition metal catalyst (e.g., an anode catalyst), which coating of film selectively allows the transport of hydrogen species (i.e., dihydrogen and hydronium) therethrough to reach the metal, and at the same time blocks corrosive species (e.g., bromine and bromide) from reaching the metal catalyst. Thus, the coating protects the anode catalyst from poisoning without substantially affecting the functionality of the catalyst during operation of a cell, such as a regenerative cell (i.e., flow battery).

The encapsulated catalyst described herein is efficient for use on a reversible anode (e.g., hydrogen electrode) of a redox flow battery system. In such a system, a suitable catalyst is attached to either or each of the system electrodes, i.e., the anode and/or the cathode.

It is also an objective of the present invention to provide a method for protecting a transition metal anode catalyst from poisoning during operation of a regenerative cell, under suitable conditions, to thereby improve fuel oxidation activity provided by the catalyst at the anode.

Thus, the technology is based on the development of a catalyst comprising transition metal nanoparticles conformally encapsulated or coated with a coating or a film of a capping agent or a capping material. The capping agent or material is selected to permit permeation therethrough of hydrogen species (e.g., dihydrogen and hydronium ions), while preventing permeating of corrosive species (e.g., bromine and bromide ions, or other halogens such chlorine and chloride ions). The capping agent or material may be selected amongst polymers and/or non-polymeric materials.

In some embodiments, the permeation of hydrogen species and prevention of permeation of corrosive species is enabled by a porosity characterized by a plurality of pores having mean pore sizes below 5 nm, or below 4 nm, or below 3 nm, or below 2 nm, or below 1 nm.

In some embodiments, the protective layer on the anode catalyst according to the invention has a porosity of between 0.1 and 1 nm mean pore size as observed from HRTEM.

In some embodiments, the capping agent is a proton conductive material that permits permeation (conductivity) of hydrogen species therethrough. The proton-conductive material may be made of a material selected from polymers, such as Nafion, and ceramics, such as titania (TiO₂), zirconia (ZrO₂), boron oxide (B₂O₃), alumina (Al₂O₃), silica (SiO₂), yttrium oxide (Y₂O₃), perovskites (e.g., barium zirconate or acceptor-doped oxides/perovskites such as Nd:BaCeO₃, Y:SrZrO₃, Y:SrCeO₃) and mixtures or combination thereof.

In some embodiments, the capping agent is selected form polydopamine, graphene oxide and polysulfonates.

In some embodiments, the capping agent is a polydopamine. It is important to note that neither reference [1] nor reference [2] above relates to fuel cells and neither teaches the use the polydopamine, as is, but rather as a precursor for carbon coating.

In some embodiments, the capping agent is a polysulfonate, optionally selected from metal (e.g., alkali and alkaline earth cations) and ammonium salts of poly(styrene sulfonic acid), poly(vinyl sulfonic acid), poly(2-aerylamido-2-methyl-1-propanesulfonic acid), naphthalene sulfonate condensates, melamine sulfate condensates, lignin sulfonate, and copolymers containing salts of styrene sulfonic acid, vinyl sulfonic acid, propane sulfonic acid, and 2-acrylamido-2-methyl-1-propanesulfonic acid, and mixtures thereof.

In some embodiments, the polysulfonate is sulfonated tetrafluoroethylene based fluoropolymer-copolymer, known as Nafion.

In some embodiments, the capping agent is or comprises graphene oxide.

In some embodiments, the capping agent is a composite material comprising one or more of the aforementioned capping agents.

The capping agent is said to “conformally” coat or encapsulate or engulf the metal nanoparticles. In other words, the capping material forms a film or a coat on the surface of the nanoparticles, such that the film or coating completely covers their outer surface, intimately following the contour of the nanoparticles. The film or coating is not partial or formed on selective regions of the nanoparticles, but rather is fully formed over their surface. The porosity present is derived from the material selected and does not exceed pores of a size larger than 5 nm. As noted herein, the porosity may be of a mean size smaller than 5 nm and at times smaller than 1 nm.

The catalysts of the invention may be similarly used in a variety of other electrochemical devices and applications. For example, the catalysts and methods of the invention may also be employed with alkaline electrochemical devices, such as alkaline fuel cells and electrolyzers, such as chlor-alkali cells and HCl electrolyzers.

It is therefore an objective of the invention to provide a transition metal catalyst conformally coated with a capping agent (polymeric, non-polymeric, e.g., polydopamine and graphene oxide, and others—as herein defined), for use in electrochemical applications. In some embodiments, the electrochemical application is oxidation of hydrogen, an application that when implemented with a catalyst of the invention, is cost-efficient with increased regenerative cell activity and efficiency, specifically, low cell resistance and high power density.

Further objectives are to provide an anode, a membrane electrode assembly (MEA) and a regenerative cell comprising the encapsulated catalyst disclosed herein.

The invention provides means and methods for protecting a catalyst by forming a coating of a capping material on the catalyst surface. In the context of the present invention, the method refers to the ability of a coating layer that is conformally coated on the surface of nanoparticles of a transition metal catalyst, to substantially prevent arrival (or contact) of poisonous species to said particles, thus inhibiting or reducing degradation of said catalyst during operation of a regenerative cell, at suitable conditions.

In the operation of a regenerative cell, corrosive species tend to bond to the surface of a transition metal catalyst on the anode side, thereby decreasing their electrochemically active surface area (EASA), resulting in degradation of the catalyst performance By providing a semipermeable conformal coating (namely, a coating that follows the contour of the particle surface) corrosive species are blocked from reaching the catalyst surface, and at the same time transport of reducing species, such as hydrogen species (dihydrogen and hydronium) is selectively permitted. The coating thereby protects the anode catalyst from such poisonous species, but does not degrade the catalyst performance by selectively permitting or allowing transport of species that are required for effective oxidation or reduction, such as hydrogen species. For example, in an HBr regenerative cell, a protective coating blocks bromide and Br⁻ ions from reaching the catalyst surface, but permits the transport of H₂ and H₃O⁺ to the EASA. The catalyst nanoparticles are configured to oxidize H₂ in discharge (HOR) and reduce H₃O⁺ in charge (HER) at the hydrogen electrode of a regenerative cell.

The catalyst of the invention is an anode catalyst (such as, Pt, Ir and Ru) that is used as a material that facilitates hydrogen oxidation reaction (also termed as “HOR”) and hydrogen evolution reaction (also termed as “HER”) during operation of a regenerative cell (for example, in a H₂/Br₂ redox flow battery).

The metal catalyst is typically of a transition metal element of the d-block of the Periodic Table of the Elements. In some embodiments, the transition metal is selected from Sc, Ti, V, Cr, Mn, Fe, Ni, Cu, Zn, Y, Zr, Nb, Tc, Ru, Mo, Rh, W, Au, Pt, Pd, Ag, Co, Cd, Hf, Ta, Re, Os, Al, Sn, In, Ga and Ir.

In some embodiments, the metal element is selected from Pt, Ru, Pd, Re, Ir, Mn, Fe, Co, Ni, Cu and mixtures thereof.

In some embodiments, the metal element is selected from Pt, Ru, Pd, Re, Ir and mixtures thereof.

In some embodiments, the metal element is selected from Ir, Pt and Ru.

In some embodiments, said element is Ir, Pt or Ru.

In some embodiments, said element is Pt.

In some embodiments, said element is Ir.

The catalyst material is typically in the form of nanoparticles having at least one dimension in the nanometer scale, i.e., lower than 1,000 nm. The catalyst nanoparticles can comprise a single or a plurality of morphologies; for example, spherical, rod shaped, cylinder shaped, hollow sphered and/or tubular.

In some embodiments, the catalyst nanoparticles have a spherical morphology. In some embodiments, the transition metal anode catalysts have a core-shell structure.

In some embodiments, the transition metal anode catalyst comprises nanoparticles having a radius of less than 100 nm, less than 50 nm, less than 40 nm, less than 30 nm, less than 20 nm, less than 10 nm, less than 8 nm, less than 5 nm, less than 4 nm, less than 3 nm, less than 2 nm, or less than 1 nm.

In some embodiments, the transition metal anode catalyst comprises nanoparticles having a radius of between 0.05 nm to 10 nm, between 0.05 nm to 8 nm, between 0.1 nm to 10 nm, between 0.1 nm to 5 nm, between 0.1 nm to 3 nm, or between 0.1 nm to 2 nm.

In some embodiments, the transition metal anode catalyst comprises nanoparticles having a radius of between 1 nm to 5 nm.

The transition metal catalyst comprises nanoparticles having a protective layer of a thickness below 20 nm (as analyzed, for example, by electron microscopy), below 15 nm, below 10 nm, below 8 nm, below 5 nm, below 4 nm, below 3 nm, below 2 nm, between 1 nm to 5 nm, or between 1 nm to 3 nm. The protective layer is conformal on the surface of the nanoparticles, coating all surface regions. The coating or film can be crystalline or amorphous, as shown by the X-Ray and electron diffraction. In some embodiments, the coating or film is amorphous and does not show any organization, as demonstrated by the absence of electron diffraction and lattice pattern in a high resolution transmission electron microscopy.

The anode catalyst may be supported by a conventional conductive carrier known to one skilled in the art. The carrier is used to disperse the catalyst and to improve physical properties including thermal and mechanical stability. To provide a supported catalyst, it is possible to use a method of coating catalyst particles on a support generally known to one skilled in the art.

Some non-limiting examples of conductive carriers include carbonaceous materials, conductive polymers and metal oxides. In case of a supported catalyst, the carbon carrier is in an amount of between 20-99 wt %, or between 30-95 wt %, or between 50-90 wt %. In some embodiments, the catalyst further comprises at least one non-metal.

In some embodiments, the anode catalyst according to the invention has a constant ZIR value when exposed to HBr (determined by ZIR technique) and the solution resistance between the working electrode and the reference electrode does not vary more than 10% to 50% in a standard rotating disc electrode (RDE) measurement of a thin layer of catalyst deposited on glassy carbon. In some embodiments, the ZIR is measured between the working electrode (RDE) and a glassy carbon counter electrode in a 3.0 mol/L solution of HBr in deionized water (>18 MΩ) at a constant temperature of 40° C., a constant potential of 0.15 V vs reversible hydrogen electrode (RHE), under 1 bar of hydrogen saturating the electrolyte for at least 8 hours.

According to another of its aspects, the present disclosure provides a method for generating electricity from a regenerative cell, the method comprising providing a regenerative cell, the regenerative cell comprising an electrode assembly (the assembly comprising an anode, a cathode and a membrane disposed between said anode and cathode); said anode comprising a catalyst layer dispersed thereon, the catalyst layer comprising transition metal nanoparticles encapsulated with a layer of a capping agent (such as polydopamine and graphene oxide); said anode catalyst layer being configured to selectively transport hydrogen species (i.e., dihydrogen and hydronium) and block poisonous species (e.g., bromide and bromine) from penetrating the layer of capping agent during operation of said regenerative cell, without substantially affecting the functionality of the anode catalyst during its operation.

The method further comprises (i) providing at least one regenerative cell comprising an electrode assembly the assembly comprising an anode, a cathode and a membrane disposed between said anode and said cathode; said anode comprising a catalyst layer dispersed thereon, the catalyst layer comprising transition metal nanoparticles encapsulated with a layer of a capping agent (such as, polydopamine and graphene oxide); (ii) contacting said anode with a fuel stream; (iii) providing the regenerative cell with suitable conditions to generate electricity; said anode catalyst layer being configured to selectively transport hydrogen species (i.e., dihydrogen and hydronium) and block poisonous species (e.g., bromide and bromine) from penetrating the layer of the capping agent during operation of said regenerative cell, without substantially affecting the functionality of the anode catalyst during its operation.

In the context of the present invention “catalyst poisoning” refers to the partial or total deactivation of the catalyst, potentially caused by compounds chemically bonding to or associating with or interacting with the active surface area of the catalyst or by chemically leaching metal atoms from the catalyst surface. Thus, the active surface area of the catalyst is reduced, decreasing its ability to oxidize the hydrogen species. For example, in RFB fuel cells catalyst poisoning is caused by the corrosion of the catalyst, i.e., leaching of metal atoms from the catalyst and inhibition of active centers through chemisorption of bromide species on the surface of the catalyst.

In the context of the present invention, a “regenerative cell” or “regenerative fuel cell” refers to a fuel cell which operates in a reverse mode with respect to a conventional fuel cell. A regenerative fuel cell consumes electrical power to convert a single or a number of compounds to new compounds which store potential energy. For example, in the charge mode of an HBr fuel cell, the fuel cell consumes electrical energy to produce H₂ and Br₂ from HBr. This allows HBr fuel cells to store energy from renewable energy sources such as wind and solar energy.

Thus, in another of its aspects, the present disclosure provides an anode for use in a redox flow battery, the anode comprising a catalytic layer comprising a transition metal catalyst disclosed herein, said catalyst being supported on a conductive carrier. Some non-limiting examples of conductive carriers include metals, carbonaceous materials, conductive polymers, metal oxides or any combination thereof. In the case of a supported catalyst, the carrier is in an amount of between 20-99 wt %, between 30-95 wt %, or between 50-90 wt %.

In the context of the present invention, a “membrane electrode assembly” (“MEA”) or “electrode assembly” refers to an assembly of electrodes, i.e., anode and cathode, for carrying out an electrochemical catalytic reaction. The electrode assembly is a unit having catalyst-containing electrodes adhered to an electrolyte membrane. In the electrode assembly, each of the catalyst layers of the anode and cathode is in contact with the electrolyte membrane. The anode is loaded with the coated nanoparticle catalyst of the present invention, and the cathode is optionally loaded with an oxygen reduction catalyst. The electrode assembly can be manufactured by any conventional method known to one skilled in the art.

The electrolyte membrane can be any material having proton conductivity, mechanical strength sufficient to permit film formation and high electrochemical stability. Some non-limiting examples of the electrolyte membrane include perfluorinated proton conducting polymers such as polyvinylidene fluoride PVDF, Nafion® PFSA or polybenzimidazole (PBI). The fuel cell is assembled by using the above membrane electrode assembly and a bipolar plate in a conventional manner known to one skilled in the art.

In other embodiments, the MEA comprises a membrane, wherein the membrane is a proton conducting membrane.

The transition metal catalyst disclosed herein can be prepared by any method known in the art. In accordance with embodiments of the present invention, the transition metal catalyst of the invention is prepared by mixing a transition metal precursor in a solvent to obtain a mixture, followed by heating said mixture at a temperature of 150° C. for, e.g., 12 hours, and then collecting said catalyst by standard collecting methods known in the art, such as precipitation and vacuum drying.

The protective layer is coated on the surface of transition metal nanoparticles according to the present invention by treating transition metal nanoparticles with a suitable precursor solution, for example, dopamine hydrochloride and a buffer, at suitable conditions to provide a conformal polydopamine coating on the nanoparticles. In some embodiments, the temperature of the treatment bath is within a range of −20 to 150° C., between 0 and 100° C., or between 10 and 50° C. In some embodiments, the encapsulated nanoparticles are then dried.

Alternatively, the protective layer is formed on the surface of the transition metal nanoparticles by treating transition metal nanoparticles with a suitable dispersion of a polymer or a large molecule like graphene oxide, at suitable conditions. In some embodiments, the temperature of the treatment bath is within a range of 20 to 300° C., 50 to 200° C., or between 100 and 200° C. In some embodiments, the heat treatment is achieved in a microwave oven. In some embodiments, the encapsulated nanoparticles are then dried.

Thus, according to yet another of its aspects, the invention provides a method of preparing an anode catalyst, the method comprising providing a solution comprising transition metal nanoparticles and a precursor; and heat treating the anode catalyst at a temperature between 80 and 500° C.

In another aspect, the present invention provides a regenerative cell comprising:

an electrode assembly, the assembly comprising an anode having a catalyst layer dispersed thereon, the catalyst layer comprising transition metal nanoparticles encapsulated with a capping agent, as disclosed herein;

wherein said catalyst layer having a molar ratio of nitrogen to carbon (N:C) in the range of 0 and 2, between 0.01 and 0.3, or between 0.05 and 0.2; and

wherein said anode is configured to oxidize hydrogen.

In some embodiments, the regenerative cell is operable at a temperature of between 25 and 120° C., between 25 and 90° C., between 40 and 70° C., or between 70 and 90° C.

In some embodiments, the regenerative cell is operable at a temperature of at most 110° C., at most 105° C., at most 100° C., at most 95° C., at most 90° C., at most 85° C., at most 80° C., at most 75° C., at most 70° C., or at most 65° C.

In some embodiments, the fuel cell is operable at a temperature of below 60° C.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B. Pt black HOR activity in 0.1 M HClO₄ aqueous solution after dipping in 3M HBr aqueous solution for different times (FIG. 1A); Same experiment with Pt black coated with polydopamine after thermal annealing (Coating #1: 5 minutes and Coating #2: 20 minutes) (FIG. 1B).

FIGS. 2A-2C. TEM of pristine Pt black with Nafion® coating (A); after 5 minutes polymer coating (B) and after thermal annealing (C).

FIGS. 3A-3C. TEM of pristine Pt black with Nafion® coating (A); after 20 minutes polymer coating (B) and after thermal annealing (C).

FIG. 4. TGA of Pt pristine and coated with polydopamine FIGS. 5A-5B. Pt coating #A TT (FIG. 5A) and (FIG. 5B): Pt coating #B TT. LSV in H₂ in HClO₄, HBr and HClO₄ after HBr.

FIGS. 6A-6B. (FIG. 6A): Pristine Ru catalyst and (FIG. 6B): coated Ru catalyst. LSV with 1 bar H₂ saturated in HClO₄, HBr and HClO₄ after HBr (0.1 M).

FIG. 7. Pristine Pt black standard accelerated test procedure in 3 M H₂ saturated HBr at 0.15 V vs SHE and 40° C. ZIR resistance, HOR activity per geometrical surface, EASA, HOR activity per Pt surface evolution with time.

FIG. 8. polymer coated Pt black standard accelerated test procedure in 3 M H₂ saturated HBr at 0.15 V vs SHE and 40° C. ZIR resistance, HOR activity per geometrical surface, EASA, HOR activity per Pt surface evolution with time.

FIG. 9. Graphene oxide coated Pt black standard accelerated test procedure in 3 M H₂ saturated HBr at 0.15 V vs SHE and 40° C. ZIR resistance, HOR activity per geometrical surface, EASA, HOR activity per Pt surface evolution with time.

FIG. 10. Diffusion parameters of H₂ for different coatings in HClO₄, HBr and HClO₄ after HBr (0.1 M) obtained from fitting the electrochemical data.

### DETAILED DESCRIPTION OF EMBODIMENTS

### Experimental Techniques

### Methods of Characterization of the Anode Catalyst:

Structure and morphology characterization

A synthetic process based on low temperature polymerization of nanometer thin coating on the catalyst (depicted in Scheme 1): After optimization, the coating protects the catalysts from inhibition effect in HBr. The process is demonstrated on different catalyst types, e.g., Pt, Ir and Ru.

The electrocatalytic performances of the catalysts are followed by cyclic voltammetry (CV), linear sweep voltammetry (LSV) and chronoamperometry (CA) on a thin film deposited on a rotating disc electrode of glassy carbon (Pine) (counter electrode: glassy carbon, reference electrode Ag/AgCl).

The following experimental conditions were applied:
CV in 0.1M HClO₄ at 298K (under Ar),
LSV on RDE (HER/HOR reaction) −0.28-0.5 V (under H₂) in 0.1M HClO₄; in 0.5M HBr; in 0.1M HClO₄,
Chronoamperometry (Controlled Potential techniques) at −0.1 V.

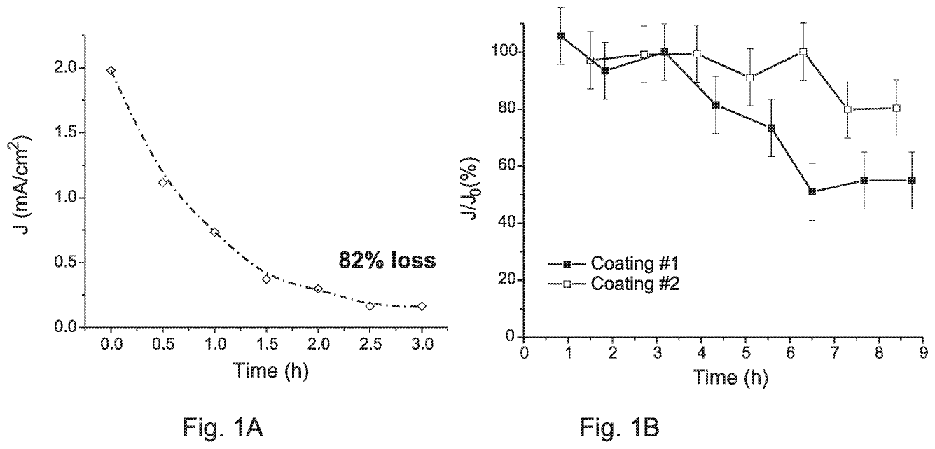

For a Pt catalyst, FIG. 1 displays the CV for the same electrode in both electrolytes (FIG. 1A). The electrochemically active surface area (ECSA) decreases in HBr due to the competitive adsorption of Br species. The activity towards H₂ is measured on the RDE at 900 rpm for the same electrode in both electrolytes. The current density decreases irreversibly and the full electrocatalytic activity is not recovered in HClO₄ (FIG. 1B).

The polymer coating is formed on the Pt black catalyst following the experimental protocol as follows. Polydopamine coating was obtained by Dopamine Hydrochloride (Dopamine Hydrochloride, Sigma Aldrich) in tris-HCl buffer solution (C=10 mMol/l-Tris-HCl Trizma base, Sigma Aldrich).

Procedures:

In a vial—to 5-7 mg catalyst, 3-4 mg Dopamine Hydrochloride was added;

1.0 ml C=10 mMol/l—Tris-HCl—Trizma solution;

The combination was stirred.

After treatment of the NPs with the dopamine solution, the residual dopamine was washed several times (3-4 times) with absolute ethanol and water (>18.2 MΩ.cm). Thereafter the catalysts sample was dried in a vacuum oven (80° C.) for 3-4 hours.

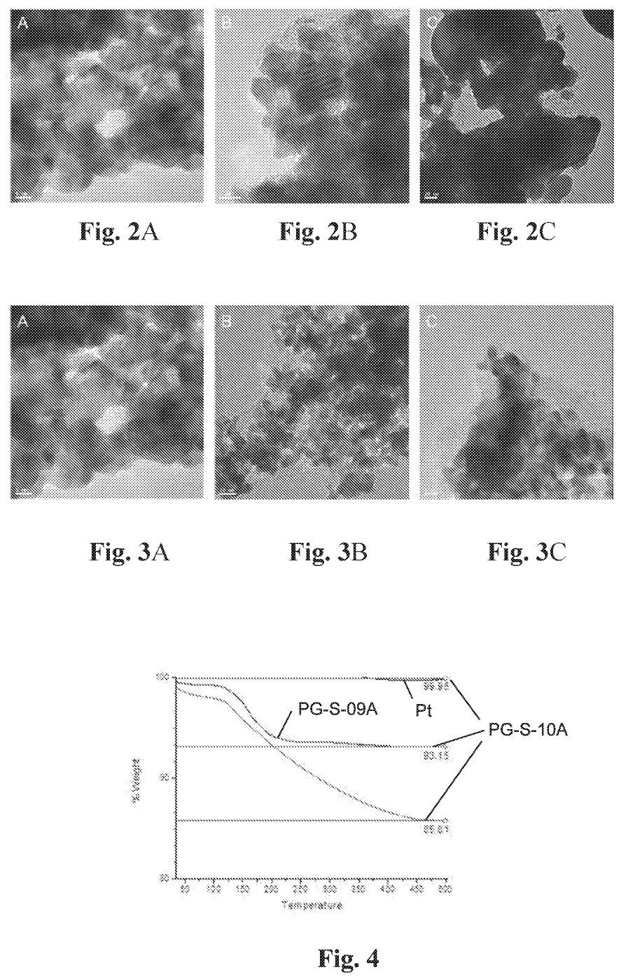

The sample was characterized by TEM and TGA. Polymer coatings #A and #B (5 and 20 minutes reaction, respectively), in pristine forms (FIG. 2A) displayed a homogeneous coating when in a porous matrix (FIG. 2B and FIG. 3B) even after thermal treatment (FIG. 2C and FIG. 3C).

The TGA analysis of the polydopamine coated samples is displayed in FIG. 4. The optimal temperature for the thermal treatment corresponds to the highest slope of the weight loss obtained from the TGA (between 150 and 200° C.).

The CV, LSV and chronoamperometric methods have been applied to all the catalysts. The best results in terms of resistance to corrosion have been obtained with Pt black catalysts coated with polydopamine after thermal treatment (#A TT and #B T T). The CA slope in 0.5 M HBr at 298K is summarized in the table below.

| | CA Slope (μA/min) for 15 |
|---|---|
| Catalyst | min in 0.5M HBr at 298K |
| Pt | −2.018 |
| Pt coating #A TT | −0.268 |
| Pt coating #B TT | −0.217 |

The corrosion is one order of magnitude slower with our a coating as compared to the pristine Pt black. The linear sweep voltammetry of the coated samples soaked in 0.5 M HBr for 15 minutes showed full recovery of the HOR activity for the Pt coating #B TT sample and 95% recovery for the Pt coating #A TT sample.

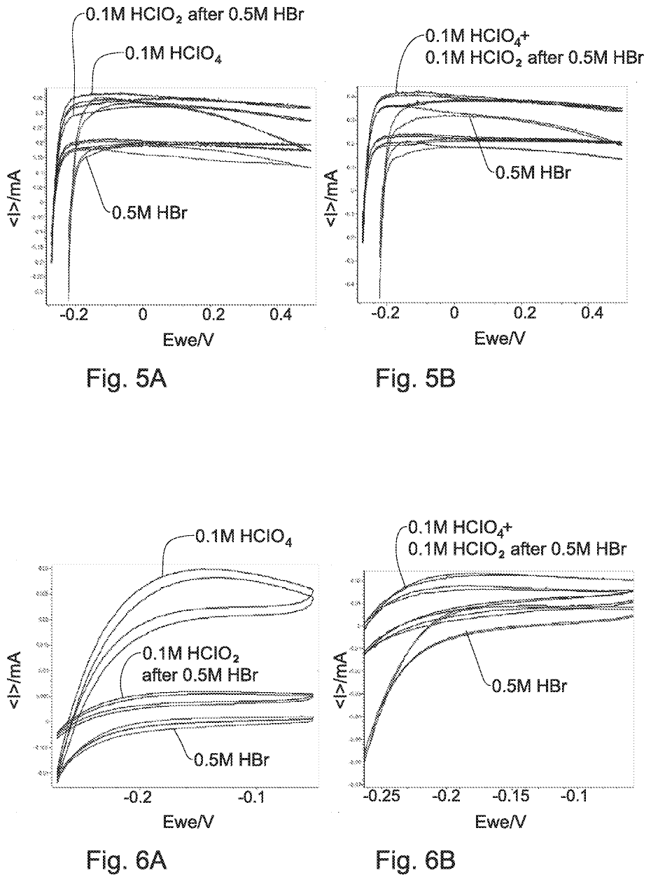

The same coating process has been applied to other metals such as Ru black. The CV, LSV and chronoamperometric methods have been applied to Ru catalysts before and after treatment and the results are reported on FIG. 6. After soaking in HBr, the coated catalyst recovered 100% of its activity (FIG. 6B) while the pristine Ru catalyst lost 90% of its activity within 15 minutes (FIG. 6A).

Both Pt and Ru pristine catalysts showed a rapid decrease of HOR activity in HBr and after soaking in HBr (0.5M). The coating of the catalysts (Pt or Ru) with polydopamine or graphene oxide prevented their degradation and avoided a reduction in their functionality. The catalysts coatings allowed selective hydrogen transport and inhibited Br poisoning.

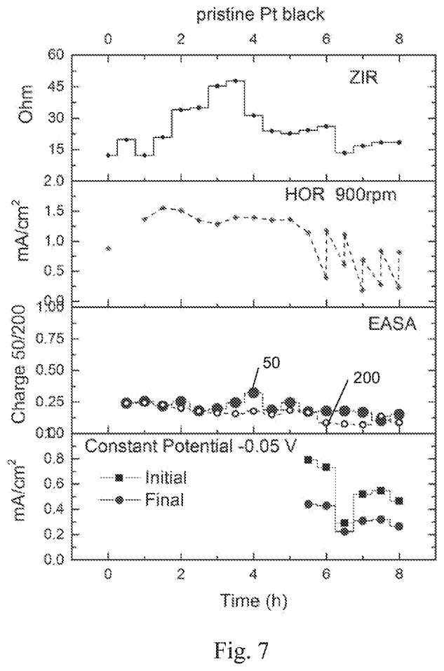

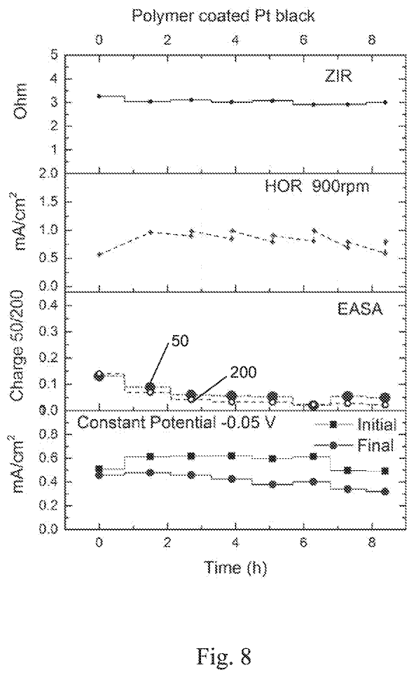

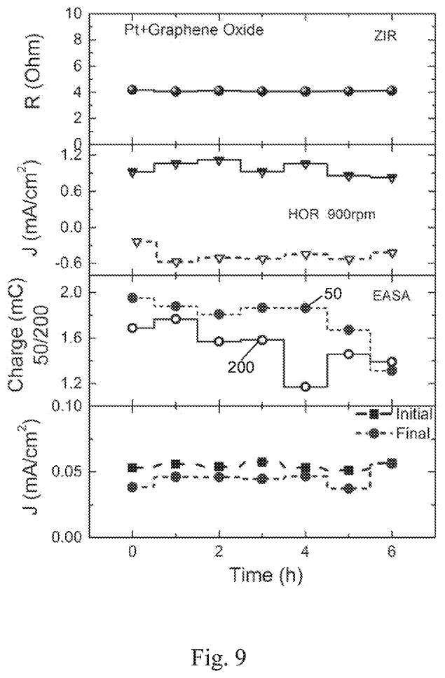

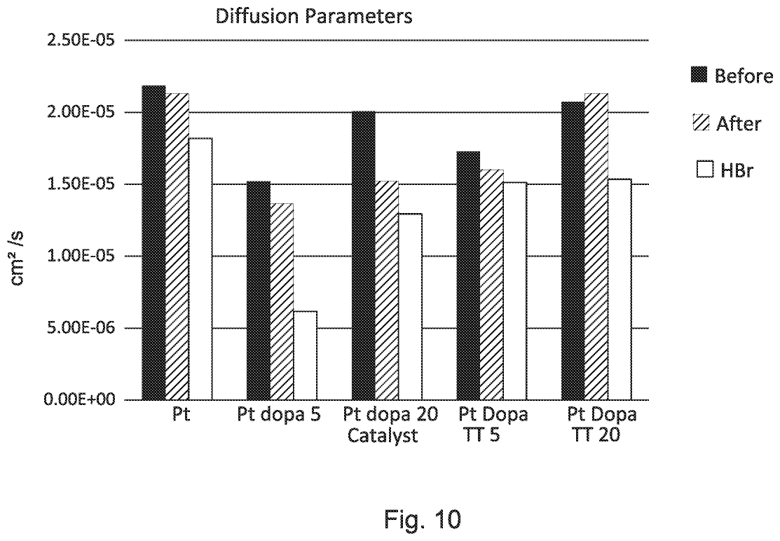

The full experimental data of an accelerated degradation test performed on three different glassy carbon RDE electrodes covered with pristine Pt black is provided in FIG. 7, polydopamine coated Pt in FIG. 8 and graphene oxide coated Pt in FIG. 9. The accelerated test was performed in concentrated HBr 3M at 40° C. over 8 hours. The measurements consisted the CV and LSV of the electrode every 30 min., while the electrode was kept in HBr solution. The following dataset: ZIR, HOR activity at 0.15 V vs SHE, EASA and HOR activity per Pt surface were tested.

The pristine Pt typically displayed large changes in the ZIR values and a decrease in HOR activity (FIG. 7). The polymer coated Pt displayed a very low variation of the ZIR (within 10% change) and a stable HOR activity (FIG. 8). The graphene oxide coated Pt displayed a very low variation of the ZIR (within 10% change) and a stable HOR activity (FIG. 9).

Thus, the coating is proposed as a generic coating for anode catalysts in H₂/Br₂ flow batteries.

1. An electrode for use in an electrochemical device, fuel cell, redox flow battery or electrolyzer, the electrode comprising a catalyst layer dispersed thereon, the catalyst layer comprising transition metal nanoparticles encapsulated with a capping agent;
wherein said catalyst layer having a molar ratio of nitrogen to carbon in the range of 0 to 2; and
said catalyst layer having porosity of between 0.1 and 1 nm mean pore size.

2.-6. (canceled)

7. The electrode according to claim 1, wherein the capping agent is selected from at least one polymeric material or at least one non-polymeric materials.

8.-9. (canceled)

10. The electrode according to claim 7, wherein the capping agent is polydopamine, graphene oxide or any mixture thereof.

11. The electrode according to claim 1, wherein the transition metal particles comprise a transition metal selected from the group consisting of Sc, Ti, V, Cr, Mn, Fe, Ni, Cu, Zn, Y, Zr, Nb, Tc, Ru, Mo, Rh, W, Au, Pt, Pd, Ag, Co, Cd, Hf, Ta, Re, Os, Al, Sn, In, Ga and Ir.

12.-14. (canceled)

15. The electrode according to claim 11, wherein the metal element is Ir, Pt or Ru.

16. The electrode according to claim 11, wherein the metal element is Pt.

17. The electrode according to claim 11, wherein the metal element is Ir.

18. The electrode according to claim 11, wherein the transition metal particles are encapsulated with a capping agent selected from polymeric or non-polymeric materials.

19. The electrode according to claim 18, wherein the capping agent is at least one polymeric material.

20. The electrode according to claim 18, wherein the capping agent is at least one non-polymeric material.

21. The electrode according to claim 18, wherein the capping agent is polydopamine, graphene oxide or any mixture thereof.

22. The electrode according to claim 1, wherein the catalyst layer comprises Ir or Pt metal particles encapsulated by polydopamine, graphene oxide or any mixture thereof.

23. The electrode according to claim 22, wherein the particles are in the form of nanoparticles.

24. (canceled)

25. An electrochemical cell comprising an electrode according to claim 1, the electrode being optionally an anode.

26. A regenerative cell comprising:
an electrode assembly comprising an anode, a cathode and a membrane disposed therebetween; said anode comprising a catalyst layer dispersed thereon, the catalyst layer comprising transition metal nanoparticles encapsulated with a capping agent;
wherein said catalyst layer having a molar ratio of nitrogen to carbon in the range of 0 to 2; and
wherein said anode is configured to oxidize hydrogen.

27. A redox flow battery comprising the electrode according to claim 1.

28. An anode electrode for use in an electrochemical device, fuel cell, redox flow battery or electrolyzer, the anode electrode comprising a catalyst layer dispersed thereon, the catalyst layer comprising Pt or Ir nanoparticles encapsulated with a capping agent selected from polydopamine, graphene oxide and mixtures thereof;
said catalyst layer having a molar ratio of nitrogen to carbon in the range of 0 to 2; and having a porosity of between 0.1 and 1 nm, mean pore size.

29.-32. (canceled)

33. The anode electrode according to claim 28, wherein the metal is Ir or Pt and the capping agent is polydopamine, or wherein the metal is Ir or Pt and the capping agent is graphene oxide.

34.-36. (canceled)

37. The anode electrode according to claim 28, when used in H₂/Br₂ flow batteries.
